(19) United States
(12) Patent Application Publication
(10) Pub. No.: US 2012/0014577 A1
(43) Pub. Date: Jan. 19, 2012

(54) Method and System for Indicating a Feeding Vessel of a Malformation

(76) Inventors: Sigrid Ferschel, Uttenreuth (DE); Vera Jünnemann, Erlangen/Dechsendorf (DE); Stefan Lautenschläger, Hausen (DE); Oliver Meissner, Erlangen (DE)

(21) Appl. No.: 12/835,162

(22) Filed: Jul. 13, 2010

(51) Int. Cl. G06K 9/00

(52) U.S. Cl. 382/131; 382/128

(57) ABSTRACT

A method for indicating a feeding vessel of a malformation is presented. The method includes accessing a medical image with the malformation and segmenting the malformation in the medical image. Further, the method includes detecting the feeding vessel of the malformation and acquiring a live image, thereafter the method involves displaying the live image overlaid with the medical image as a displayed image and indicating the feeding vessel in the displayed image.

### FIELD OF THE INVENTION

The present invention relates to computer aided diagnostics and more particularly to a method and a system for indicating a feeding vessel of a malformation.

### BACKGROUND OF THE INVENTION

Malformations such as tumors can occur in any part of the human body causing pain and discomfort. Malformations may be cancerous sometimes or benign in other cases.

Malformations include fibroid tumors, which are also known as myomas. Fibroid tumors are benign tumors that originate from the smooth muscle layer, known as myometrium and the accompanying connective tissue of the uterus. Fibroids are the most common benign tumors in females and typically found during the middle and later reproductive years, generally in the age group of 35 to 45 years. Most fibroids are asymptomatic but some can grow and cause heavy and painful menstruation, painful sexual intercourse, and urinary frequency and urgency.

Currently, the fibroids can be treated by several techniques such as hysterectomy, which involves complete removal of the uterus. Myomectomy is another technique, in which the fibroid is surgically removed while keeping the uterus intact. Recently, uterine fibroid embolization (UFE) is being used to treat fibroids. UFE involves blocking or stopping the flow of blood supply to the fibroid. The technique involves injecting a catheter in the uterine arteries supplying blood to the fibroid which injects small particles into the arteries to stop supply of blood to the fibroid.

Presently, a patient is placed on a table and catheter injected in her uterine artery. A high dosage of contrast agent is injected and continuous X-ray images of the uterus region are taken which provide a road map of blood supply to the uterus and fibroids to a medical practitioner, such as a doctor. The doctor then guides the catheter to the artery supplying blood to the fibroid and thereafter blocks the flow of blood by injecting an embolic material into the uterine artery. This technique of performing UFE involves injecting high dosage of contrast agent for acquisition of images. A high dosage of contrast agent and repeated exposure to radiation may be harmful to the patient and may cause adverse affects.

It is therefore desirable to provide an improved clinical workflow for performing UFE by decreasing the dosage of radiation as a result of repeated X-ray image acquisitions.

### SUMMARY OF THE INVENTION

Briefly in accordance with one aspect of the present invention a method for indicating a feeding vessel of a malformation is presented. The method includes accessing a medical image with the malformation and segmenting the malformation in the medical image. Further, the method includes detecting the feeding vessel of the malformation and acquiring a live image, thereafter the method involves displaying the live image overlaid with the medical image as a displayed image and indicating the feeding vessel in the displayed image.

In accordance with another aspect of the present invention, a system for indicating feeding vessel in a malformation is presented. The system includes a display adapted to display a medical image having the malformation and its surrounding vessels, a selector for manually selecting the malformation. The system further includes a processor for segmenting the malformation, detecting the feeding vessel of the malformation and accessing a live image. In addition, the display is further adapted to display the live image overlaid with the medical image as a displayed image and indicate the feeding vessel in the displayed image.

### BRIEF DESCRIPTION OF THE DRAWINGS

The present invention is further described hereinafter with reference to illustrated embodiments shown in the accompanying drawings, in which:

FIG. 1 is a flow chart depicting an exemplary method for indicating a feeding vessel of a malformation;

FIG. 2 illustrates a flow chart depicting the workflow to embolize a fibroid;

FIG. 3 illustrates a block diagram of a system for indicating a feeding vessel of a malformation in a medical image;

FIG. 4 is a diagrammatical illustration of uterus region including fibroid and feeding vessels;

FIG. 5 is a blown-up view of the feeding vessel of FIG. 4 with a marked position of a catheter;

FIG. 6 illustrates the feeding vessel with a marked position of a catheter along with distal feeding vessel branches;

FIG. 7 illustrates the feeding vessel of the fibroid with a repositioned catheter position;

FIG. 8 illustrates the feeding vessel of the fibroid with the repositioned catheter position and an updated display of distal vessel branches;

FIG. 9 illustrates a flowchart of a method for indicating a feeding vessel of a malformation in a medical image;

FIG. 10 illustrates a flow chart depicting a workflow to embolize a feeding vessel of a malformation;

FIG. 11 illustrates a flow chart of a method for determining properties of a vessel in a medical image;

FIG. 12 shows a segmented vessel in a medical image, for which the maximum curvature is determined using the centerline,

FIG. 13 shows a tubular structure, for which the maximum curvature is determined;

FIG. 14 shows an approximated tubular structure, for which the maximum curvature is determined; and

FIG. 15 illustrates a point in the feeding vessel where a vessel parameter is determined for a portion of the feeding vessel.

### DETAILED DESCRIPTION OF THE INVENTION

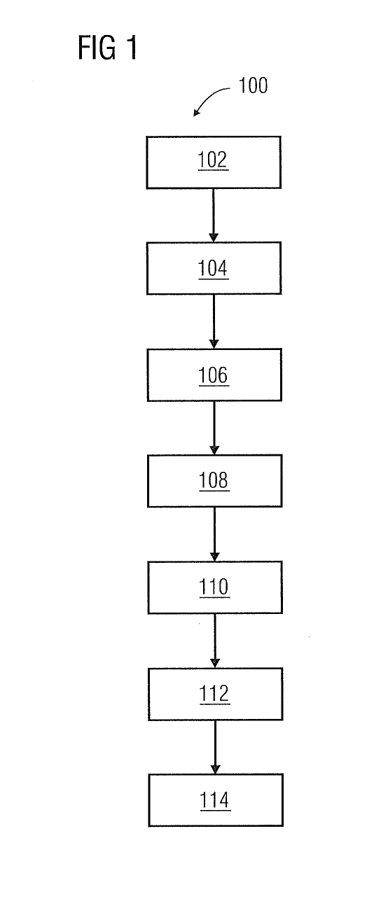

FIG. 1 illustrates a flow chart 100 of a method for indicating a feeding vessel of a malformation in a uterus region in a medical image. As used herein, the term ‘malformation’ refers to an abnormal formation or development of a tissue or an organ. Malformation may include a tumor, a fibroid or any other malformation which may be benign or cancerous. The method involves displaying a high resolution medical image of the malformation and its surrounding vessels at step 102. The surrounding vessel consists of a feeding vessel or a plurality of feeding vessels which supply blood to the malformation, such as a fibroid.

In accordance with aspects of the present technique, the medical image is an MRI image, a CT image or a C-arm CT image. Furthermore, the medical image is typically an image with the malformation. In addition, the medical image may also be obtained using a commonly known medical 2D or 3D image acquisition. The 3D acquisition can be for example a 3D X-ray angiography, or a CT image acquisition; the 2D acquisition can be for example a digital angiography (DA) or a digital subtraction angiography (DSA). In a DSA, a final medical image is generated as a difference between two images, one obtained from injecting a contrast agent and the other obtained without injecting the contrast agent to the vessels. However, use of MRI for imaging minimizes exposure of radiation to the patient.

At step 104, a physician manually selects a portion of the displayed medical image in reference to the position of the malformation. In the present embodiment, a portion of the medical image selected is the malformation itself, which includes either a part of the malformation or the whole malformation including the feeding vessel. The selection can be done by providing a marking on the medical image. The marking may be in the form of a point, a line, a circle or a contour encircling the malformation. The malformation is easy to locate for the physician to make a selection since the malformation is clearly visible in the medical image. Since one objective of the method is to indicate the feeding vessels of the malformation, selection of the malformation will increase the chance of detecting most of the feeding vessels supplying blood to the malformation, since most of the feeding vessels will have a point of contact with the malformation.

At step 106, the malformation is segmented. The selection of the malformation at step 104, initiates an automatic segmentation of the malformation which may be performed by dedicated software. As will be appreciated, different algorithms may be used to perform the segmentation. One such segmenting algorithm that can be employed is “region growing algorithm” which is also known as a pixel based image segmentation algorithm. A point or a region in the malformation is first selected; thereafter neighboring pixels of the initially selected point or the region are compared with the pixels of the point or the region based on for example, the pixel intensity, gray level texture, or color. It may be noted that if the difference of pixel-value or the difference value of average gray level of a set of pixels is less than a “similarity threshold value”, the regions will be considered as a same region. This segmentation continues till the boundary of the malformation thereby defining the extent of the malformation.

In one embodiment, the method of segmentation, as at step 106 may be repeated for a region having multiple malformations, such as fibroids. In accordance with aspects of the present technique, the physician can improve the segmentation result interactively until result from the segmentation is sufficient to identify the malformation in the patient's body.

At step 108, a feeding vessel of the malformation is detected. The feeding vessel supplies blood to the malformation and assists in the growth of the malformation. In an exemplary embodiment, a centerline of the feeding vessel is calculated. The determination of centerline is an important step for analyzing the feeding vessel. The centerline is used to analyze, rebuild and visualize the feeding vessel of the malformation. The centerline is calculated using a dedicated software tool, although, other algorithms known to person skilled in the art may be used to calculate the centerline of the feeding vessel feeding the malformation. By calculating the centerline of the feeding vessel information such as the maximum curvature of the feeding vessel, pathological changes, vessel overlapping and bifurcations are accurately and easily determined.

In accordance with aspects of the present technique, several parameters of the feeding vessel such as, the maximum curvature, the length of the feeding vessel and a minimum diameter of the feeding vessel may be determined by calculating the centerline of the feeding vessel. However, it may be noted that various other techniques may be employed to determine the above-mentioned parameters of the feeding vessel. The knowledge of the feeding vessel parameters helps the physician to make a correct choice on the diameter, make, stiffness or flexibility of the catheter for the intervention. Based on these parameters the method may also include suggesting a type of catheter which is suitable for intervention of the feeding vessel.

In an alternative embodiment, the feeding vessel of the malformation is detected by detecting the direction of blood flow in the feeding vessel at the selected point. The feeding vessel can be a combination of a parent vessel and a plurality of sub vessels. The sub vessels are vessels that bifurcate from the parent vessel wherein a sub vessel has a smaller diameter than the parent vessel in the blood flow direction after a point of bifurcation. The parent vessel and the sub vessels, which originate from the same parent vessel, may be indicated with a variation in color. By indicating the parent vessel and the sub vessel in a different color, for example dark red for the parent vessel and light red for the sub vessels, it is easier to identify the different kinds of vessels. The physician can check whether the sub vessel also feeds the malformation or just healthy surrounding tissue, so that the physician can identify at which point the parent vessel can be embolized to minimize the number of sub vessels feeding only healthy tissue being cut-off from the blood supply.

In accordance with aspects of the present technique, the blood flow direction may be identified using any method known to a person skilled in the art. One way of identifying the blood flow direction involves determining a diameter of the feeding vessel in at least two places along a length of the feeding vessel, wherein the blood flow direction is identified as the direction of a decreasing diameter of the feeding vessel. In the human body, the blood vessels are arranged to supply blood from the heart to organs, where the anatomical structure ensures that the diameter of the blood vessels in the direction of the blood flow decreases as the blood vessel approaches the organs. Similarly, the feeding vessel supplies blood to the malformation, the feeding vessel can be traced back from the malformation in the direction opposite to the blood flow direction and hence can be indicated in the medical image. Therefore, determining the blood flow direction in the above mentioned way is easy and accurate.

Further, at step 110, a live image is obtained which includes the malformation and its surrounding vessels. This live image is generally a low resolution two-dimensional (2D) image; however the live image may also be a three-dimensional (3D) image. This live image may be obtained using a DynaCT, or 3D Angio scan, for example. The live image is obtained at the time of actual treatment and may not have any indications like the medical image, since the live image is obtained from a low dose scan, which is generally a rotational scan to enable the dose to get spread to the entire region. It may also be noted that the live image is not required to be used for diagnostic purposes.

At step 112, the live image is overlaid with the medical image to obtain a fused image; this fused image is displayed on a display unit and will be referred to as a displayed image hereinafter. Generally, fusing two images obtained for same part of an organ or tissue enables the visualization of all features in both the images in one single image. By first obtaining the high resolution medical image it is sufficient to only obtain low resolution live images, since the detailed anatomical structure of the malformation and the surrounding vessels from the medical image is visible in the displayed image. The displayed image, in the presently contemplated configuration, will have components of both the medical image and the live image. Since the medical image is a high resolution image indicating at least one feeding vessel and one or more sub-vessels of this feeding vessel, the displayed image will have these components clearly visualized on it with respect to the live image, so that the physician can see the position of the malformation and the feeding vessel before he proceeds with the actual intervention. Based on the indications in the medical image, the displayed image shows segmented malformation, the feeding vessels and a desired position for embolization. The use of a high resolution medical image, such as the MRI image at the planning stage allows the use of low resolution live images when overlaying the live images at the treatment stage. By performing the overlaying, the malformation and the feeding vessels are clearly visible in the live image, which provides the physician an orientation to move and place a catheter according to the centerline of the feeding vessels and the malformation outline extracted from the medical image.

In accordance with aspects of the present technique, the overlaying step 112 of the medical image and the live image includes registering the medical image with the live image. The registration may be an intensity based image registration or a feature based image registration. In the presently contemplated configuration, feature based image registration between the medical image and the live image is performed. As an example, the medical image and the live image of a uterus region are registered taking the pelvic bones as landmarks for the registration. The registration step enables geometrical relationship between the medical image and the live image obtained at step 110. The registration process between the medical image and the live image causes the fusion of the medical image and the live image if the medical image and the live image are obtained from different modalities. Also, any movements or change in the position of the patient during image acquisitions can be compensated by image registration.

Furthermore, at step 114, the feeding vessel is indicated in the displayed image based on the information of the malformation and the feeding vessels obtained from the medical image. More particularly, the feeding vessel in the displayed image is indicated based on the calculation of the centerline of the feeding vessel of the malformation. Uterine fibroid embolization (UFE) can be performed by the physician on the patient as will be described hereinafter.

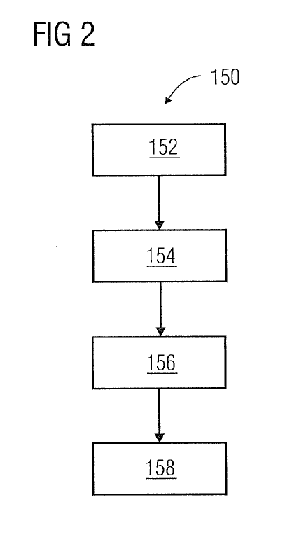

FIG. 2 is a flow chart 150 depicting the workflow to embolize a fibroid present in a uterus region of the patient. Although, the workflow is described with respect to the embolization of a uterine fibroid, it should however be noted that similar methodology may be extended for embolization associated with other pathological structures. As previously described with reference to FIG. 1, the medical image of the uterus region of the patient is accessed wherein the medical image is an MRI image, as at step 152. Thereafter, a segmentation process of the fibroid is performed to detect the extent of the fibroid. In addition, the feeding vessels are also detected as previously described with reference to FIG. 1.

At step 154, a live image of the uterus region having the same malformation and the feeding vessels is obtained. This live image is obtained at the time of the intervention using a low dose scan, as described with reference to FIG. 1.

A physician is able to perform UFE intervention by the help of the overlay of the fibroid and the feeding vessels obtained from the medical image with the live image and this information is utilized for performing navigation of the feeding vessel by a catheter. The information regarding the location of the malformation and the feeding vessel in the live image obtained from the overlay is helpful in guiding the physician to instantly place a catheter in a desired position for applying the embolization material. This guidance makes the whole treatment process faster compared to the existing method of finding a proper catheter position during treatment using contrast-enhanced image acquisitions.

Furthermore, at step 156, the catheter is navigated in the feeding vessel according to the centerline of the feeding vessel; the centerline of the feeding vessel provides information about the direction for navigation in the feeding vessel and maximum curvature of the feeding vessel, pathological changes, vessel overlapping and bifurcations.

During the actual intervention, the physician moves the catheter to the desired position. The indications in the displayed image provide guidance to move the catheter to the desired position. Guiding support is provided not only by the graphically marked catheter position but also by the indicated sub vessels in the medical image. During the intervention the live image is continuously updated and fused with the medical image to show the actual position of the catheter. At step 158, the embolization material is administered to the feeding vessel at the desired position by the catheter to embolize the feeding vessel of the fibroid.

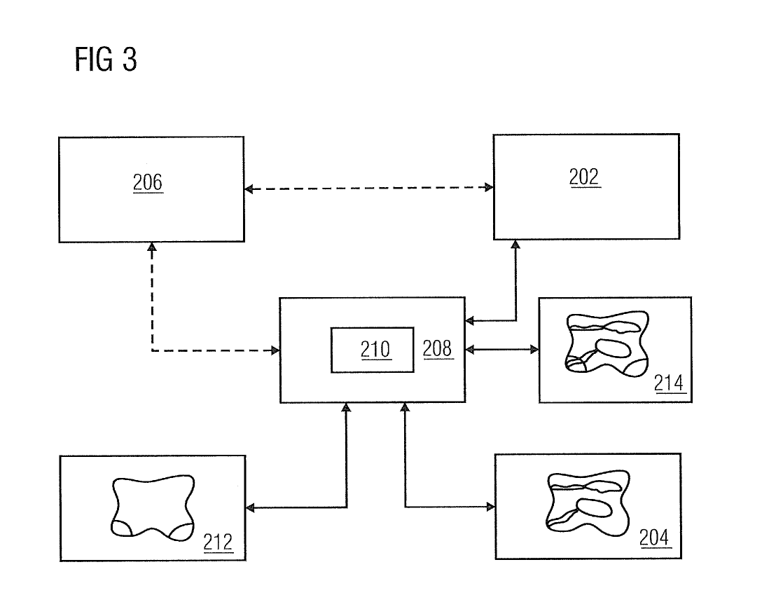

FIG. 3 is a diagrammatical illustration of a system 200 for detecting a feeding vessel of a malformation. It may be noted that the system 200 is a standard computer with a software application running on it. The system 200 includes a display unit 202 adapted to display a medical image 204 having the malformation and its surrounding vessels. A physician can manually select a portion of the medical image 204 in reference to the malformation using a selector 206. The selector 206 can be a graphic tool, for example which can be used for highlighting or marking a specific portion in the medical image 204. The selector 206 is a functional element of the system which allows identifying a portion of the medical image 204 by user interaction. The selector 206 can be realized as a feature of a software program executed on the system 200.

In accordance with aspects of the present technique, the portion of the medical image 204 could be a part of the malformation or even could be the whole malformation itself. The display 202 is connected to a processor 208, which is used for segmenting the malformation. The segmentation process of the malformation has been described with reference to FIG. 1. Furthermore, the processor 208 is configured to detect the feeding vessels of the malformation in the medical image 204.

The processor 208 is configured to overlay the medical image 204 and the live image 212. More particularly, the processor 208 is configured to overlay the segmented malformation and the feeding vessels in the medical image 204 with the live image 212 obtained during intervention with the catheter. As previously noted with reference to FIG. 1, overlay of the medical image 204 and the live image 212 includes registration of the medical image 204 and the live image 212. The processor 208 is further configured to register the medical image 204 and the live image 212. Also, the live image 212 is acquired using a DynaCT or 3D Angio scan. More particularly, the processor 208 includes a registration module 210 to register the medical image 204 and the live image 212 and produce a fused image which is displayed in the display 202.

The display 202 is further adapted to display the overlay of the live image 212 and the medical image 204 including the malformation and the surrounding vessels as a displayed image 214 during an intervention with the catheter to embolize the feeding vessel. The display 202 is also adapted to display the complete segmented malformation alongwith the feeding vessels, a part of the segmented malformation or the feeding vessels in different color or all of the above features or a combination of the above mentioned features.

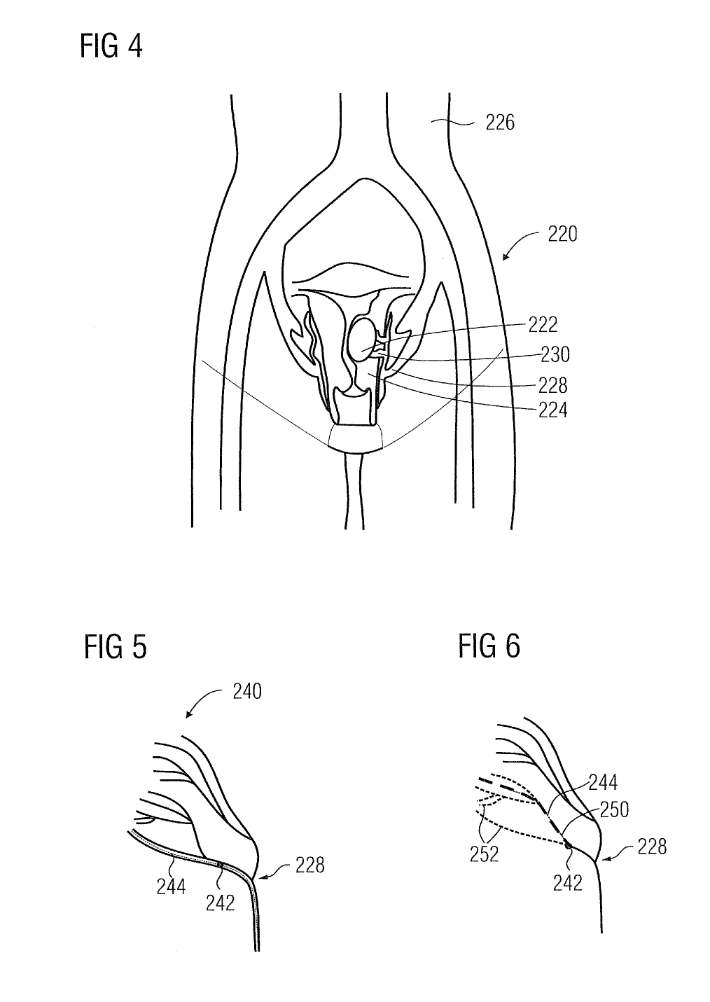

FIG. 4 is a diagrammatical illustration of a part of medical image 220 depicting the uterus region. As illustrated, fibroids 222 are present in the uterus 224 of the patient 226, which are supplied blood by the uterine artery 228. The portion of the uterine artery 228 that supplies blood to the fibroid 222 is the feeding vessel 230 as indicated in FIG. 4. The fibroid 222 as shown is a segmented fibroid. The fibroid 222 and the feeding vessel 230 may be represented in color so as to distinguish from the background of the medical image.

FIG. 5 is a blown-up view 240 of the feeding vessel 228 of FIG. 4, with a desired marked catheter position 242. The marking can be a graphical marking made using the selector. The marked catheter position 242 is an initial position selected by the physician to see the simulation of embolization, considering that the embolization is done at the marked catheter position 242. The simulation will provide an indication on the vessels affected by the embolization prior to the actual intervention procedure. Reference numeral 244 is representative of the centerline of the feeding vessel 228.

FIG. 6 illustrates the feeding vessel 228 of the fibroid 222 with the marked position 242 of the catheter alongwith the distal feeding vessel branches. The distal vessel branches after the marked position 242 are indicated along the blood flow direction in a different color to distinguish itself from rest of the feeding vessel 228 and also from the background of the medical image. As illustrated in FIG. 6, the distal vessel branches may be represented in the form of dotted lines. The distal vessel branches can have a main feeding vessel 250 and sub vessels 252. As an example, the main feeding vessel 250 and sub vessels 252 can be indicated in different colors. Alternatively, the main feeding vessel 250 is represented by a thick dotted line and the sub vessels 252 by thin dotted lines for distinction.

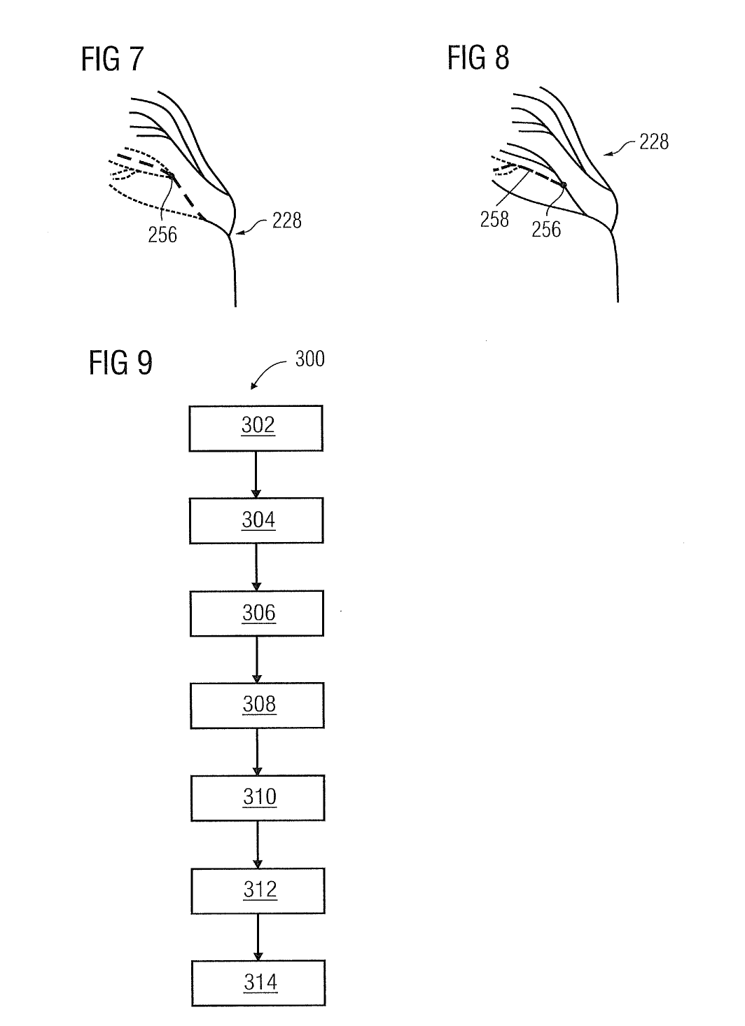

FIG. 7 illustrates the feeding vessel 228 of the fibroid 222 (see FIG. 4) with a repositioned catheter position 256. It can be seen that the initial marked catheter position 242 in FIG. 6 is different when compared to the repositioned catheter position 256 in FIG. 7. The physician has done a remarking of the desired catheter position in the medical image. The advantage for the physician is that he can perform different iterations to visualize different simulation of embolization and finally select a more accurate catheter position which will not cutoff any major vessels feeding to the healthy tissues.

FIG. 8 illustrates the feeding vessel 228 of the fibroid 222 with the repositioned catheter position 256 and an updated display of distal vessel branches 258 based on the repositioning. The physician can perform multiple repositioning until an optimal point is reached.

The proposed workflow for indicating a feeding vessel of a malformation to perform uterine fibroid embolization has several advantages such as, by having the ability to overlay the corresponding structures of the medical image 204 (see FIG. 3) to the live images, such as the live image 212 (see FIG. 3) at the time of intervention gives a very fast and reliable way to detect the feeding vessel of the malformation. Furthermore, the above mentioned process also minimizes exposure of radiation to the patient. Additionally, by having all the information at the right place and right time ensures an improved workflow for the physician, increases quality and reduces cost by saving time. A single MRI scan instead of repeated X-ray scans of the patient also reduces cost for the workflow and increases the clinical outcome for the patient which results in faster examination time, thereby reducing the clinical complication rate. The process described hereinabove is also implemented as a dedicated system or software running on a computer thereby reducing the need of manual intervention to a large extent.

Furthermore, to perform an embolization procedure, repeated contrast-acquisitions and analysis of the images are required to find the correct position of the catheter, as well as subsequent/more distal vessel branches, which finally makes the procedure difficult and time consuming. By having the indication of the feeding vessel in the medical image, the physician can use the medical image to plan the catheter position or even simulate an embolization prior to the actual treatment thereby avoiding multiple contrast enhanced image acquisitions which otherwise would have been required. Avoiding multiple contrast enhanced image acquisitions reduces the risk of high dosage X-rays and contrast agents to the patient. Since the planning of the treatment can be done prior to the treatment, the duration required for treatment is less.

The above described embodiments were directed to the indication of the feeding vessel of the malformation in the uterus region, however, it may be noted that the process can be utilized for any region or part in the human body.

Accordingly, FIG. 9 illustrates a flow chart 300 of a method for indicating a feeding vessel of a malformation in a medical image. The method involves displaying a high resolution medical image of a malformation and its surrounding vessels at step 302 and corresponds to the step 102 and 152 of FIG. 1 and FIG. 2 respectively. The surrounding vessel consists of a feeding vessel or a plurality of feeding vessels which supply blood to the malformation. At step 304, the physician manually selects a portion of the displayed medical image in reference to the position of the malformation. In the embodiment described with reference to FIG. 1, the portion of the medical image selected is the malformation itself as at step 104. However in the present embodiment, either a part of the malformation can be selected or the whole malformation along with the feeding vessel. At step 306, the feeding vessel of the malformation is segmented. This may be done in addition to the step 106 of FIG. 1 and presents an alternative case for segmentation. The selection of the malformation at step 304, initiates the automatic segmentation of the malformation as well as the feeding vessels of the malformation. At step 308, the segmented feeding vessel is then indicated in the medical image. At step 310, the physician selects a point in the segmented feeding vessel. At step 312, the blood flow direction at the selected point is identified. At step 314, based on the blood flow direction at the selected point in the feeding vessel a part of the feeding vessel is indicated in the blood flow direction after the point. The indicated part of the vessel corresponds to the region which would be blocked if the embolizing material would be released at that point. The method therefore can be used to simulate the effect of the embolization procedure on the feeding vessel and the point selected in step 310 corresponds to the point in the feeding vessel where the physician would like to inject an embolization material, for example using a catheter in this simulation.

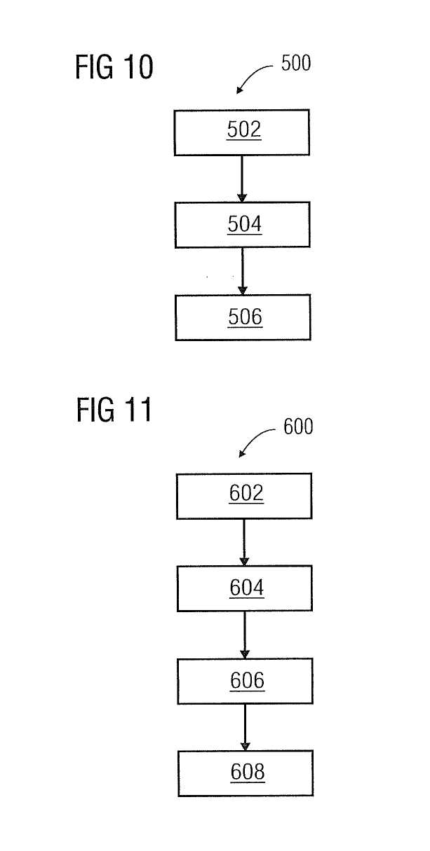

Further the medical image, which contains the indication of the segmented malformation as well as the feeding vessels, can be fused with a live image acquired during the time of the embolization procedure to provide an indication of the malformation as well as the feeding vessel in the live image. Accordingly, FIG. 10 illustrates a flow chart 500 depicting the workflow to embolize a feeding vessel of a malformation which also includes the workflow for embolization of the feeding vessel of a malformation as described with reference to FIG. 2. At step 502, the medical image is obtained for which an intended catheter position was determined as explained in FIG. 9. At step 504 a live image is obtained for the same malformation and the surrounding vessels which is generally a low resolution 2-dimensional image. At step 506, the live image is overlaid with the medical image to obtain a fused image. By performing the overlaying, the planned position and the feeding vessels are clearly visible in the merged image, which provides the physician an orientation to move and place the catheter in said planned position. This guidance makes the whole treatment process faster comparing to the existing method of finding a proper catheter position during treatment using contrast-enhanced image acquisitions.

When considering an embolization of a feeding vessel of a malformation, the physician will be interested in plurality of factors. For example the vessel or vessels which needs to be embolized, the point at which the embolization material should be injected which will be the intended catheter position, the vessel parameters like the maximum curvature of the vessel, the smallest diameter of the vessel, the blood flow direction etc. In addition to the indication of the planned catheter position and the affected vessels along the blood flow direction which are affected by the embolization it will be useful if any critical vessel parameters also can be determined for the vessel. The vessel parameter, for example the maximum curvature and the smallest diameter of the vessel along the length of a vessel till the planned catheter position will help the physician take critical decision on the selection of the catheter type. Therefore in addition to the workflow described with reference to FIG. 2, the present technique may also be used for selection of catheter for intervention required for embolization procedure.

By having the indication of the segmented vessel in the medical image as proposed in the invention the physician can further use the medical image to find the maximum curvature of the vessel and plan the catheter type based on this parameter of the vessel prior to the actual intervention. The prior planning also helps to speed up the actual procedure, since the required catheter type for a given vessel can be determined before said procedure based on the maximum curvature information.

Accordingly, FIG. 11 illustrates a flow chart 600 of a method for determining properties of a vessel in a medical image, such as the feeding vessel as mentioned with reference to FIG. 1. At step 602, the medical image of the vessel is displayed. The medical image is a high resolution image. At step 604, the vessel displayed in the medical image is segmented. At step 606, the segmented feeding vessel is then indicated in the medical image. And at step 608, a maximum curvature along a length of the vessel is determined. The knowledge of the maximum curvature of the vessel helps the physician to make correct choice of the catheter having proper stiffness or flexibility which can be easily maneuvered through the vessel without much difficulty.

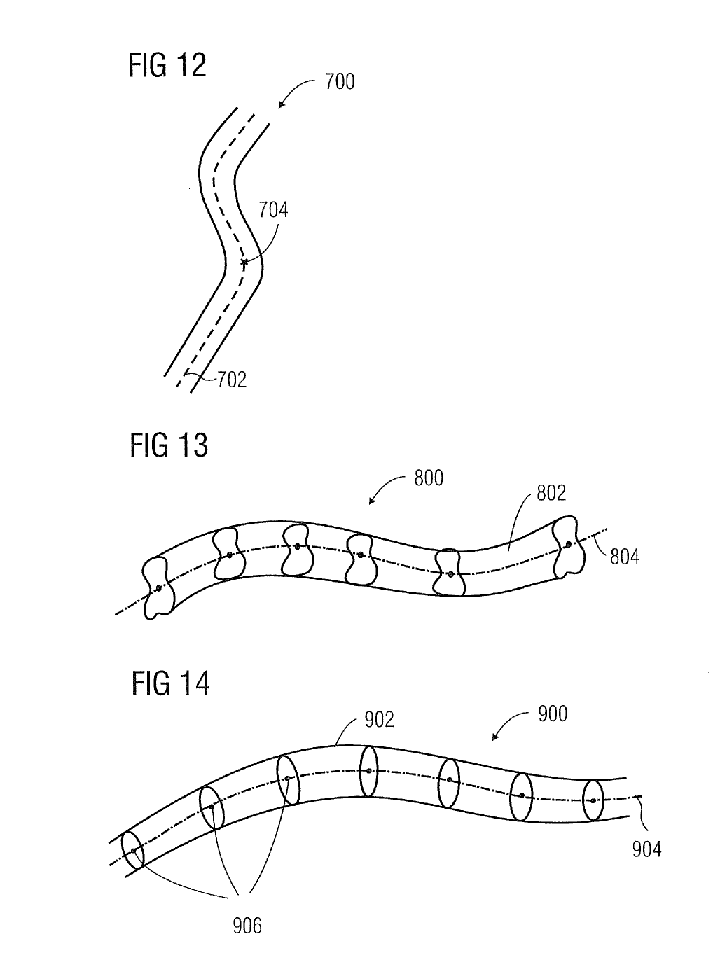

Different methods could be employed to determine the maximum curvature of a blood vessel. FIG. 12 shows a segmented vessel 700 in a medical image, for which the maximum curvature of the centerline 702 is at point 704. In said embodiment, the maximum curvature of the segmented vessel 700 corresponds to the maximum curvature at the point 704. This is one way to find the maximum curvature of a vessel or a selected part of the vessel.

FIG. 13 shows a segmented vessel 800, which is having a tubular structure 802 for which the maximum curvature need to be determined. The tubular structure 802 is segmented from a high resolution medical image, which provides the actual vessel situation inside a body part. In the case of the tubular structure 802, a centerline 804 is first determined and an average diameter at different points of the centerline 804 is determined. The maximum curvature can, for example, be based on the Gaussian curvature of the tubular structure 802 or based on other appropriate definitions of the curvature.

In another embodiment, FIG. 14 shows an approximated tubular structure 900, obtained for a selected portion of a segmented vessel in the medical image. The vessel parameters are then determined for this approximated tubular structure 900. In this embodiment, the centerline 904 of the selected portion of the segmented vessel 902 is computed and thereafter the average diameter of the segmented vessel at different points 906 along the centerline 904 is computed.

In the above-mentioned embodiments i.e. in the tubular structure 802 or the approximated tubular structure 900 the maximum curvature can also be taken as the maximum curvature of a path having shortest distance between two ends of the selected segmented vessel. In another embodiment, a curve inside a tubular structure 802 is fitted such that its maximum linear curvature is minimal.

Determination of the maximum curvature using centerline as explained using FIG. 12 does not require medical image of very high resolution, hence the above determination is preferred when the resolution of the medical image is relatively low. The accuracy of determined maximum curvature is highest when said determination is done using the tubular structure 802 as explained using FIG. 13, since the tubular structure 802 provides a real situation of the vessel inside a body part. At the same time the determination using the tubular structure 802 requires a medical image of relatively high resolution. The maximum curvature determined using the approximated tubular structure 900 has an accuracy lesser than that of the one determined using the tubular structure 802 but generally higher than that of the one determined using the center line, since the tubular structure is only an approximated model and not an actual vessel situation.

The diameter information of the vessels is another vessel parameter in which a physician might be interested. Based on the above embodiment, i.e. using the tubular structure 802, the smallest diameter information can be determined. It may be noted that the above-mentioned workflow may be used for a vessel which may be any tubular anatomic structure of a human or an animal. In the embodiments described with reference to the figures the vessel is a blood vessel. However, the vessel can also be any other tubular structure including but not limited to bronchi, esophagus, and intestine.

In another embodiment, the selection of a point in the feeding vessel of a tumor according to step 310 in FIG. 9 can trigger the indication of the segmented feeding vessel along the blood flow for which vessel parameters like maximum curvature could be determined. Hence in this embodiment instead of indicating the segmented feeding vessels in the blood flow direction as described in step 314 of FIG. 9, a portion of the feeding vessel is indicated in the opposite direction of the selected point. The vessel parameters, like the maximum curvature or smallest diameter of this indicated portion of the feeding vessel will be of interest to the physician for an intervention using a catheter.

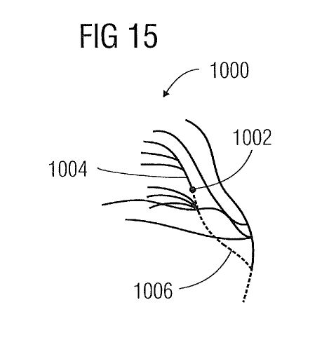

FIG. 15 illustrates a feeding vessel 1000 and a point 1002 in the feeding vessel 1000 selected by the physician where the catheter can be positioned to inject an embolization material. Based on the selected point 1002, an indication of a portion 1006 of the feeding vessel 1000 can be provided in the medical image. The indicated portion 1006 is shown as a dotted line till the point 1002 and does not extend to distal vessel branches 1004 after the point 1002. The vessel parameters in the blood flow direction up to the selected point 1002 of the portion 1006 are taken into consideration, since this will provide critical guidance to the physician for an intervention procedure.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

1. A method for indicating a feeding vessel of a malformation, comprising:
accessing a medical image comprising the malformation and surrounding vessels;
segmenting the malformation in the medical image;
detecting the feeding vessel of the malformation;
acquiring a live image;
overlaying the live image with the medical image to generate a displayed image;
displaying the displayed image; and
indicating the feeding vessel in the displayed image

2. The method according to claim 1, wherein the medical image is an MRI image, a CT image or a C-arm CT image.

3. The method according to claim 1, further comprising selecting a portion of the medical image for identifying the malformation to be segmented.

4. The method according to claim 1, further comprising identifying a blood flow direction in the feeding vessel for indicating the feeding vessel of the malformation in the displayed image.

5. The method according to claim 4, further comprising determining a diameter of the feeding vessel in at least two points along a length of the feeding vessel, and wherein the blood flow direction is oriented from a larger diameter towards a smaller diameter of the feeding vessel.

6. The method according to claim 1, further comprising calculating a centerline of the feeding vessel of the malformation for indicating the feeding vessel in the displayed image.

7. The method according to claim 6, further comprising navigating a catheter through the feeding vessel according to the centerline of the feeding vessel.

8. The method according to claim 7, wherein the catheter is navigated through the feeding vessel to a desired position to embolize the feeding vessel.

9. The method according to claim 1, wherein the live image is acquired through a low dose scan.

10. The method according to claim 1, wherein the live image is registered with the medical image.

11. The method according to claim 1, wherein the malformation and the feeding vessels is indicated with different colors.

12. A system for indicating a feeding vessel of a malformation, comprising:
a display device adapted to display a medical image comprising the malformation and surrounding vessels;
a selector for manually selecting the malformation; and
a processor for segmenting the malformation, detecting the feeding vessel of the malformation and accessing a live image,
wherein the display device is further adapted to display the live image overlaid with the medical image as a displayed image and indicate the feeding vessel in the displayed image.

13. The system according to claim 12, wherein the medical image is an MRI image, a CT image, or a C-arm CT image.

14. The system according to claim 12, wherein the processor is configured to overlay the live image with the medical image.

16. The system according to claim 12, wherein the display device is further adapted to display the segmented malformation and the feeding vessel in the live image.

17. The system according to claim 12, wherein the display device is adapted to display the live image of the malformation and the feeding vessel obtained during an intervention with a catheter to embolize the feeding vessel.

18. The system according to claim 12, wherein the processor comprises a registration module to register the medical image with the live image.

19. The system according to claim 12, wherein the processor is further adapted to calculate a centerline of the feeding vessel in the medical image.

20. The system according to claim 12, wherein the processor is further adapted to identify a blood flow direction in the feeding vessel.
